(19) United States
(12) Patent Application Publication
(10) Pub. No.: US 2006/0164596 A1
(43) Pub. Date: Jul. 27, 2006

(54) Polarized lens for sun glasses, and method of manufacturing

(76) Inventor: Di Hwe Yeh, Keelung (TW)

Correspondence Address: NATH & ASSOCIATES, 112 South West Street, Alexandria, VA, 22314, US

(21) Appl. No.: 11/038,243

(22) Filed: Jan. 21, 2005

(51) Int. Cl. G02C 7/10

(52) U.S. Cl. 351/163

(57) ABSTRACT

The invention is directed to a structural improvement in a polarized safe sun lens that is comprised mainly of a base-material and PVA film (polarized film). The base-material is an integral, one piece of material that is formed in a particular curved radian and thickness. The contact surfaces of base-material and the PVA film are adhered and fixed together. A special chemical is applied on the outer surfaces of both of the base-material and the PVA film; then comprising of the sun lens is finished. The optical properties of the lens agree to the criteria of international standard.

### FIELD OF THE INVENTION

The present invention relates in general to the manufacture of a polarized safety lens for sun glasses and the resulting sun lens, and it especially relates to a structural improvement in one kind of structure of a sun lens.

### BACKGROUND OF THE INVENTION

It is well known to those skilled in the art of polarized sun glasses that the lens are comprised of a first base-material comprised of a glass, a PC (plastics), an MMA (acrylics), a CR resin (heat-forming resin), a CAB (acetic acid cellulose), or similar well known materials.

The structure of a polarized sun lens is traditionally made by a laminated manufacturing process or method. With reference to FIG. 3, first a planar material is processed to have an outer surface that is a first plate base-material 11, an intermediate layer that is a polarized film 12, sometimes called a PVA film, and an inner layer that is a second plate base-material 13. These three layers are adhered together and fixed as an integral planar material having an upper outer surface 15 of the first base material and a lower outer surface 16 of the second base material. Then a coating material is applied on outer surface 15 of the first base-material 1 and on the outer surface 16 of the second base-material 2. This coating is a chemical that forms a coating layers 14. The laminate or sandwich of materials is heated to soften it, and then it is then pressed or vacuum pulled, including into a mold, to form a particular shape. This finishes the manufacturing of a polarized sun lens. The finished product is depicted in FIG. 4.

The polarized sun lens manufactured according to the process described above comprises supplying a first and a planar base-material and a PVA film; forming a planar laminate with the PVA film in the middle; then heating the materials to soften them and bend them to a particular radian of curvature. This manufacturing process has several steps which increase the deviation from products, raises the unqualified yield rate of the products, and also increases the number of manufacturing man-hour. Finally the increment in manufacturing costs can not be reduced, and the resulting products have optical properties which are not in accordance with the criteria of international standards.

### SUMMARY OF THE INVENTION

Considering the aforementioned problems the present inventor used his experience accumulated through many years to solve the prior art problems.

The invention involves a method for improving the structure of a polarized sun lens and the resulting lens. According to the present invention, a lens is comprised of a laminate of a base-material and PVA polarized film. The base material of the invention which is a complete configuration in the shape and form of the sun lens, has a specific radian and thickness and in a preferred embodiment is made by injection molding and provided to the process of making the lens. The base-material and PVA polarized film are adhered together and fixed to yield the resulting laminate. Then a layer of a coating with a special chemical is spread on each outer surface of base-material and PVA film to complete the making of the lens.

The lens structure of the present invention comprises a laminate of a base-material and PVA film (polarized film), and with a coating layer on the outer surfaces of the base-material and the PVA film. The coating layer is a special chemical with scratch-resistant, abrasion-resistant, waterproof, protecting, and supporting functions etc. The invention effectively shortens the manufacturing processes, increases the fine yield rate, results in saving of the costs, and finally increases of the competitiveness of the product in the world market.

The process according to the present invention includes providing a base-material that already has the desired configuration and curvature of radius to a desired radian. This replaces the process of molding a planar base-material such as with vacuum molding. Such a procedure according to the present invention simplifies the steps of manufacture and precludes a lot of complicated processing steps. This results in a saving of manufacturing man-hours, an increased and good yield rate, and lowered costs. The invention has a simple structure and high practicability, and it can be produced easily and conveniently. The structure of products of polarized sun lens by the design according to the present inventin results in an increased assurance of quality which can meet the criteria of optical properties of international standards and of a user's requirements and demands.

### BRIEF DESCRIPTION OF THE DRAWINGS

FIG. 1 is a sectional view of an embodiment of the present invention showing the structural improvement of polarized safe sun lens.

FIG. 2 is a sectional view of another embodiment showing the structural improvement of polarized safe sun lens.

FIG. 3 is a sectional view of a sandwiched or laminated structure of a polarized sun lens according to a prior art method of manufacture which is well-known to those skilled in the art.

FIG. 4 is a sectional view of polarized sun lens after the vacuum molding of the laminated structure depicted in FIG. 3 according to a prior art method of manufacture which is well-known to those skilled in the art.

### DETAILED DESCRIPTION OF THE PREFERRED EMBODIMENTS

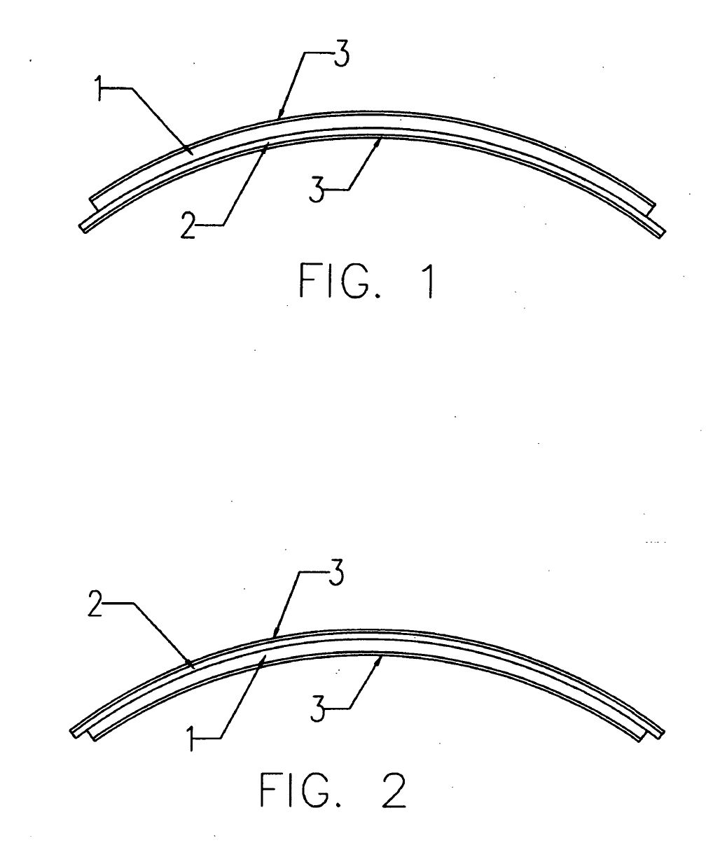

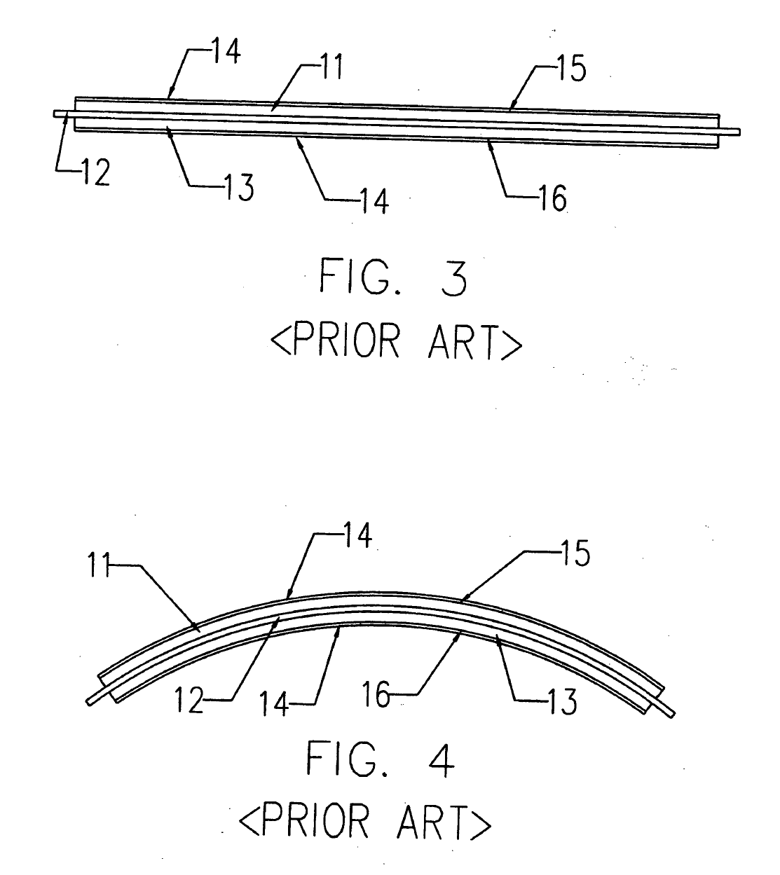

The invention relates to a structural improvement of a polarized safe sun lens. With reference to FIG. 1 and FIG. 2, there is depicted a lens according to the present invention. The lens comprises a base-material 1 and a PVA film or polarized film 2 that are adhered together to form a two layer laminate using a conventional adhesive or bonding agent.

Base-material 1 has been previously made or formed using conventional processes in the desired shape of a formed complete lens. For example, the shape of base-material can be made by injection molding. Base-material 1 has a particular curved or arcuate shape with a desired curvature of a predetermined, conventional radian with a conventional thickness. Base-material 1 is made from a material selected from glass, or PC (plastics), or MMA (acrylic), or CR resin (heat-firming resin), or CAB (acetic acid cellulose). Other conventional materials that have the desired clarity and light transmissive characteristics can also be used.

PVA film 2 can be any conventional material that is flexible and compatable with base-material 1 so that the two can be completely adhered to one another.

On both the outer layer of base-material 1 and the outer layer of PVA film 2 is a conventional coating 3 that is comprised of a silicon gel. The particular silicon gel and the characteristics thereof are selected so as to provide scratch-resistant, abrasion resistant, waterproofing, physical protection, and support and strength functions.

Base-material 1 can be the outer layer and PVA film 2 can be the inner layer, as depicted in FIG. 1. Alternatively, the two layers can be reversed and base-material 1 is the inner layer and PVA film 2 is the outer layer. Both of base-material (1) and PVA film (2) can have a variety of different colors and both can have the same color or their color can be different.

The base-material according to the invention is formed to the shape with a crooked specific radian via injection molding. The structure of the safe polarized sun lens only needs base-material and PVA film to finish the lens. So the manufacturing process is simplified and a multi-step process is avoided. This results in man-hour saving, the good yield rate rising, finally the costs lowering. The invention has a simple structure and high practicability, easy to produce. The optical properties of the invention meet the criteria of the international standard, and also satisfy the user's demand. Therefore the competitiveness of the products increases.

After the contact surfaces of the base-material (1) and PVA film (2) have completely adhered to each other through the use of a conventional adhesive and have fixed, a layer of a special chemical such as a silicon gel coating 3 is spread on both sides of the base-material 1 and PVA film 2 to finish the polarized safe sun lens.

Altogether, the present invention has been described in connection with preferred embodiments, it will be understood that it is not so limited. On the contrary, it is intended to cover all alternatives, modification and equivalents as may be included within the spirit and scope of the claims of the invention as set forth herein as is known to those skilled in the art.

### DESCRIPTION OF ELEMENTS

1 base-material
2 VA film (polarized film)
3 coating layer
11 base-material 1
12 VA film (polarized film)
13 □□□base-material 2
14□□□Coating layer
15 □□□outer surface of base-material 1
16□□□inner surface of base-material 2

What is claimed is:

1. A structural improvement of a polarized safety sun lens, comprising
a main base-material;
a PVA polarized film that have been adhered together with an adhesive; and
a coating layer on both outer sides of the base-material and of the PVA film.

2. A structural improvement of a polarized safety sun lens according to claim 1, wherein the base-material is whole-figuration with particular crooked radian and thickness as its characteristic.

3. A structural improvement of a polarized safety sun lens according to claim 1, wherein the base-material is selected from glass, or PC (plastics), or MMA (acrylic), or CR resin (heat-firming resin), or CAB (acetic acid cellulose) to comprise. The base-material is also suitable to select from various kinds of medias.

4. A structural improvement of a polarized safety sun lens according to claim 1, wherein the base-material of the polarized safe sun lens is made in round, or square shape. It is also suitable to make into various shapes.

5. A structural improvement of a polarized safety sun lens according to claim 1, wherein the structure comprises both of base-material and PVA film. Base-material and PVA film can be composed with different colors as its characteristic.

6. A structural improvement of a polarized safety sun lens according to claim 5, wherein the base-material may be used as an outer layer and PVA film used as an inner layer, or reversely the base-material used as an inner layer and PVA film used as an outer layer.

7. A structural improvement of a polarized safety sun lens according to claim 1, wherein the coating layer is a special chemical.

8. A process of making a structural improvement of a polarized safety lens comprising
providing a pre-formed base-material;
providing a PVA polarized film;
adhering one side of said base-material to one side of said PVA film to form a laminate, the respective sides being referred to as the contact surfaces;
allowing the laminate to set so as to be fixed; and
applying a coating on both outer sides of said base-material and said PVA film.

9. The process of making a structural improvement in a polarized safety lens as claimed in claim 8, wherein the base-material is whole-configuration with a particular curve of a preselected radian and thickness.

10. The process of making a structural improvement of a polarized safety lens as claimed in claim 8, wherein the base-material is selected from glass, or PC (plastics), or MMA (acrylic), or CR resin (heat-firming resin), or CAB (acetic acid cellulose).

11. The process of making a structural improvement of a polarized safety lens as claimed in claim 8 where in said coating is a silicon gel.
